(19) United States
(12) Patent Application Publication
(10) Pub. No.: US 2013/0132599 A1
(43) Pub. Date: May 23, 2013

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Kousuke Nakashima, Kawasaki-shi (JP)

(73) Assignee: CANON KABUSHIKI KAISHA, Tokyo (JP)

(21) Appl. No.: 13/678,291

(22) Filed: Nov. 15, 2012

(30) Foreign Application Priority Data
Nov. 18, 2011 (JP) 2011-252925

(51) Int. Cl. G06F 15/16

(52) U.S. Cl. 709/230

(57) ABSTRACT

An information processing apparatus includes a web browser configured to receive from the server, an HTTP response including a first script in which a procedure for using a web service is described and a second script in which a procedure for returning a result of the web service to a server is defined, and an HTTP server configured to perform processing as a web service provided by the information processing apparatus according to execution of the first script by the web browser, and call the second script for transmitting the result of the web service to the server. The web browser performs control to transmit the result of the web service to the server according to calling of the second script by the HTTP server.

### BACKGROUND OF THE INVENTION

1. Field of the Invention

The claimed invention generally relates to information processing and, more particularly, to an information processing apparatus connected to an external apparatus via a network, and provided with a browser capable of displaying data containing a script received from the external apparatus.

2. Description of the Related Art

Conventionally, there have been generally known multifunction peripherals by which users can use image processing functions such as a copying function and a print function. Further, there have been also generally known configurations in which such multifunction peripherals include web browsers.

Japanese Patent Application Laid-Open No. 2008-003833 discusses a method for using the above-described copying function with use of a web browser of a multifunction peripheral. According to the method discussed in Japanese Patent Application Laid-Open No. 2008-003833, the multifunction peripheral including the web browser receives HyperText Markup Language (HTML) data containing a JavaScript (registered trademark) code from a server apparatus on a network, and controls a transition of a copying screen according to the JavaScript (registered trademark) code. Further, according to the method discussed in Japanese Patent Application Laid-Open No. 2008-003833, information for calling a web service published by the multifunction peripheral is described in the JavaScript (registered trademark) code. Then, the web browser of the multifunction peripheral is configured to generate a Simple Object Access Protocol (SOAP) message for calling the web service based on the information acquired from the JavaScript (registered trademark) code.

According to the method discussed in Japanese Patent Application Laid-Open No. 2008-003833, the web browser in the multifunction peripheral generates a SOAP request based on the description of the JavaScript (registered trademark) code received from the server apparatus, and calls the web service in the multifunction peripheral. In other words, it is not the server apparatus but the web browser of the multifunction peripheral that generates the SOAP request for calling the web service in the multifunction peripheral.

Therefore, it is difficult to perform the following processing by the method discussed in Japanese Patent Application Laid-Open No. 2008-003833. That is, it is difficult to conduct interactive processing between the server apparatus and the multifunction peripheral by the method discussed in Japanese Patent Application Laid-Open No. 2008-003833, such as transmitting a SOAP response, which is a response to a SOAP request generated based on the description of the JavaScript (registered trademark) code, from the multifunction peripheral to the server apparatus, and transmitting a new SOAP request according to the SOAP response from the server apparatus to the multifunction peripheral.

### SUMMARY OF THE INVENTION

The claimed invention is directed to means enabling a web browser in an information processing apparatus to execute a script to call a web service within the information processing apparatus, and to use the web service according to a SOAP message generated by an external apparatus.

According to an aspect of the claimed invention, an information processing apparatus communicable with an external apparatus via a network includes a web browser configured to transmit a HyperText Transfer Protocol (HTTP) request to the external apparatus, and receive an HTTP response including a first script in which a procedure for using a web service is described and a second script in which a procedure for transmitting a result of the web service to the external apparatus is defined, from the external apparatus according to the HTTP request, and an HTTP server configured to perform processing as a web service provided by the information processing apparatus according to execution of the first script by the web browser, and call the second script for transmitting the result of the web service to the external apparatus. The web browser performs control to transmit the result of the web service to the external apparatus according to calling of the second script by the HTTP server.

According to the aspect of the claimed invention, it is possible to cause the web browser in the information processing apparatus to execute the script to call the web service within the information processing apparatus, and to use the web service according to the SOAP message generated by the external apparatus.

Further features and aspects of the claimed invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the claimed invention and, together with the description, serve to explain the principles of the claimed invention.

FIG. 1 is a view illustrating an entire information processing system including a multifunction peripheral (MFP) and a server.

FIG. 2 is a block diagram illustrating a hardware configuration of the MFP.

FIG. 3 is a block diagram illustrating a hardware configuration of the server.

FIG. 4 is a view illustrating a software configuration of the MFP.

FIG. 5 is a view illustrating a software configuration of the server.

FIG. 6 is a view illustrating transition of a screen displayed on an operation unit 219 of the MFP of FIG. 2.

FIG. 7 illustrates a sequence of processing performed by the information processing system.

FIG. 8 is a view illustrating an example of a SOAP request (eXtensible Markup Language (XML) data) generated by a SOAP proxy of the server.

FIG. 9 is a view illustrating an example of HTML data for displaying a scan request screen, which is generated by an eXtensible Stylesheet Language Transformations (XSLT) processor of the server.

FIG. 10 is a view illustrating an example of a SOAP response output from a SOAP service to a proxy service of the MFP.

FIG. 11 is a view illustrating an example of an HTTP response for a callback of a SOAP response by the proxy service of the MFP.

FIG. 12 is a flowchart illustrating processing of an HTTP request, which is performed by the proxy service of the MFP.

FIG. 13 is a view illustrating a software configuration of a server according to a second exemplary embodiment.

FIG. 14 illustrates a sequence of processing performed by an information processing system according to the second exemplary embodiment.

FIG. 15 is a view illustrating an example of HTML data for displaying a scan instruction screen according to the second exemplary embodiment.

### DESCRIPTION OF THE EMBODIMENTS

Various exemplary embodiments, features, and aspects of the claimed invention will be described in detail below with reference to the drawings.

Exemplary embodiments, which will be described below, are not intended to limit the scope of the claimed invention as encompassed by the accompanying claims. Further, not all of combinations of features described in the descriptions of the exemplary embodiments are necessarily essential to a solution according to the claimed invention.

### <Configuration of Information Processing System>

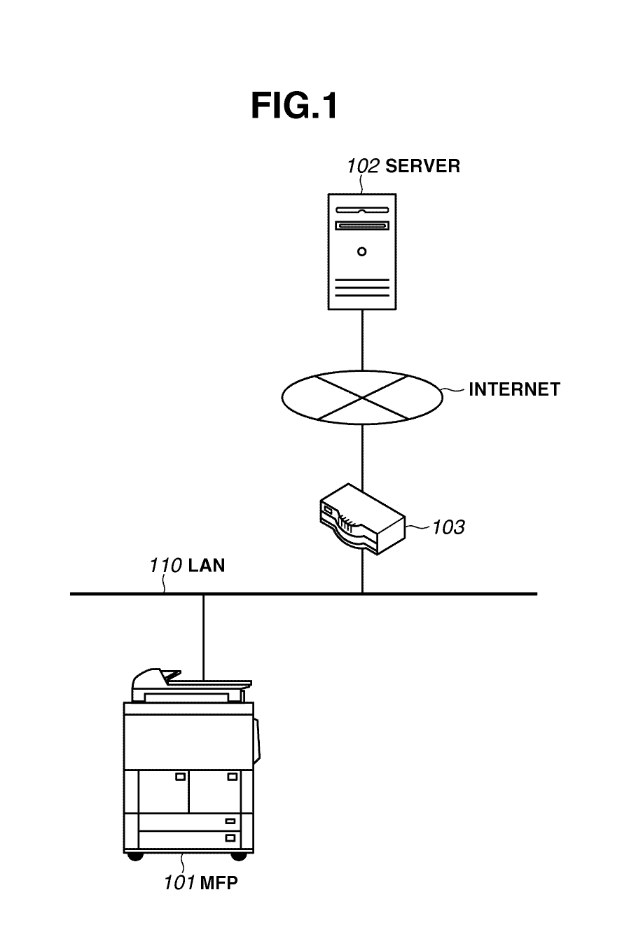

FIG. 1 is a view illustrating a configuration of an information processing system according to a first exemplary embodiments of the claimed invention. An MFP 101 is connected to a local area network (LAN) 110, and the MFP 101 is communicably connected to a server 102 via the Internet. A broadband router 103 is connected between the LAN 110 and the Internet. The broadband router 103 is configured to accept a request from the MFP 101 to the server 102, but reject a request from the server 102 to the MFP 101. However, since a request from the MFP 101 to the server 102 is accepted, transmission of information from the server 102 to the MFP 101 can be realized by inserting a message from the server 102 in a response to the request.

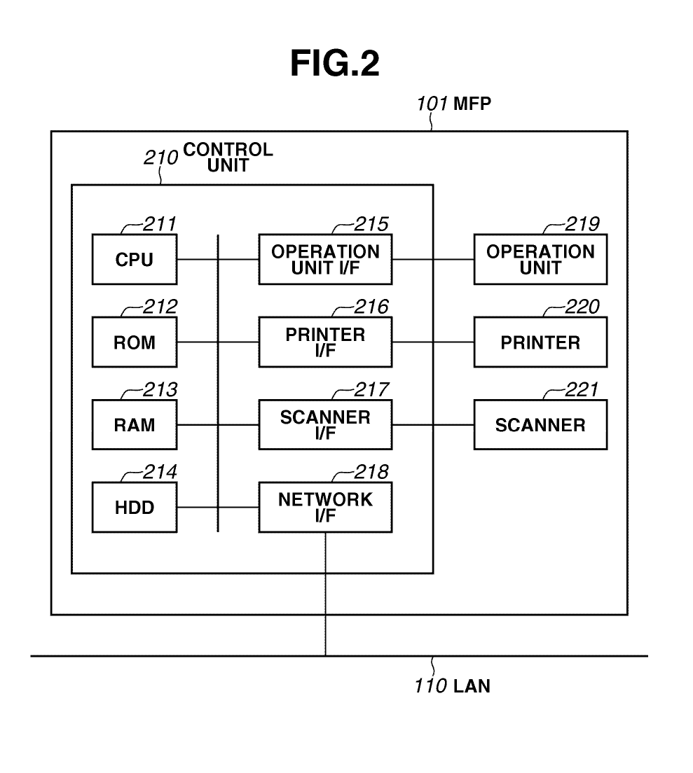

FIG. 2 is a block diagram illustrating a hardware configuration of the MFP 101. A control unit 210 including a central processing unit (CPU) 211 controls operations of the entire MFP 101. The CPU 211 reads out a control program stored in a read only memory (ROM) 212, and performs various types of control such as reading control and transmission control. A random access memory (RAM) 213 is used as a temporary storage area such as a main memory or a work area of the CPU 211.

A hard disk drive (HDD) 214 stores image data and various programs. An operation unit interface (I/F) 215 connects an operation unit 219 and the control unit 210. The operation unit 219 includes, for example, a liquid crystal display unit having a touch panel function, and a keyboard. Further, the MFP 101 has a web browser function, which will be described below. The web browser analyzes HTML data received from the server 102, and displays an operation screen based on the description of the received HTML data on the liquid crystal display unit of the operation unit 219.

A printer I/F 216 connects a printer 220 and the control unit 210. The control unit 210 transfers image data to be printed to the printer 220 via the printer I/F 216, and causes the printer 220 to print the image data on a recording medium.

A scanner I/F 217 connects a scanner 221 and the control unit 210. The scanner 221 reads an image on a document to generate image data, and inputs the generated image data to the control unit 210 via the scanner I/F 217.

A network I/F 218 connects the control unit 210 of the MFP 101 to the LAN 110. The network I/F 218 transmits image data and information to an external apparatus (for example, the server 102) on the LAN 110, and receives various types of information from an external apparatus on the LAN 110.

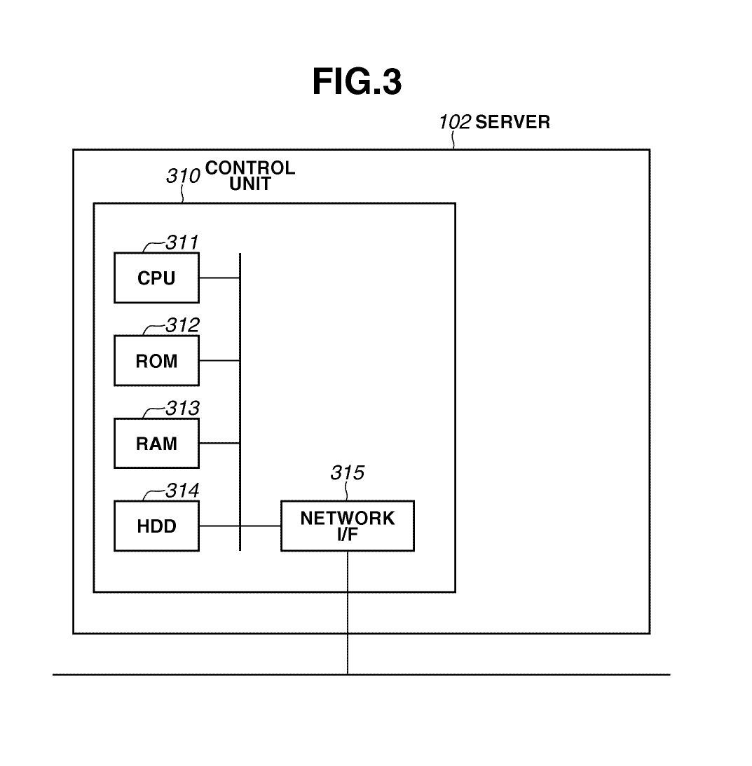

FIG. 3 is a block diagram illustrating a hardware configuration of the server 102. A control unit 310 including a CPU 311 controls operations of the entire server 102. The CPU 311 reads out a control program stored in the ROM 312 and performs various types of control processing. A RAM 313 is used as a temporary storage area such as a main memory or a work area of the CPU 311. An HDD 314 stores image data and various programs.

A network I/F 315 connects the control unit 310 (the server 102) to the LAN 110. The network I/F 315 transmits and receives various types of information between the server 102 and another apparatus on the LAN 110.

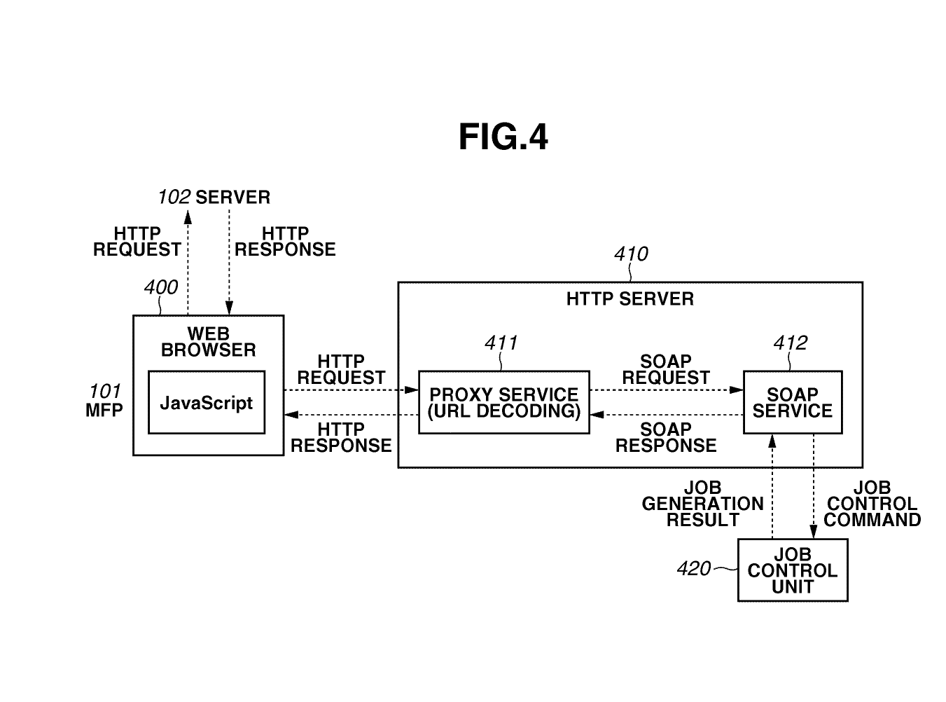

FIG. 4 is a view illustrating a software configuration of the MFP 101. The CPU 211 included in the MFP 101 executes the control program stored in the ROM 212, by which the respective functional units illustrated in FIG. 4 are realized.

The MFP 101 includes a web browser 400, an HTTP server 410, and a job control unit 420.

The web browser 400 transmits a request according to the HTTP protocol (hereinafter referred to as an “HTTP request”), and receives a response to the transmitted request (hereinafter referred to as an “HTTP response”). Then, the web browser 400 analyzes the received HTTP response to display an operation screen. If a JavaScript (registered trademark) code is included in the received HTTP response, the web browser 400 processes the JavaScript (registered trademark) code. In other words, the web browser 400 can dynamically overwrite the operation screen and transmit a new HTTP request by processing the JavaScript (registered trademark) code.

The HTTP server 410 receives an HTTP request from the web browser 400, and assigns the request to a specified web service (a proxy service 411 in the present exemplary embodiment).

Web services published by the HTTP server 410 include the proxy service 411 and a SOAP service 412.

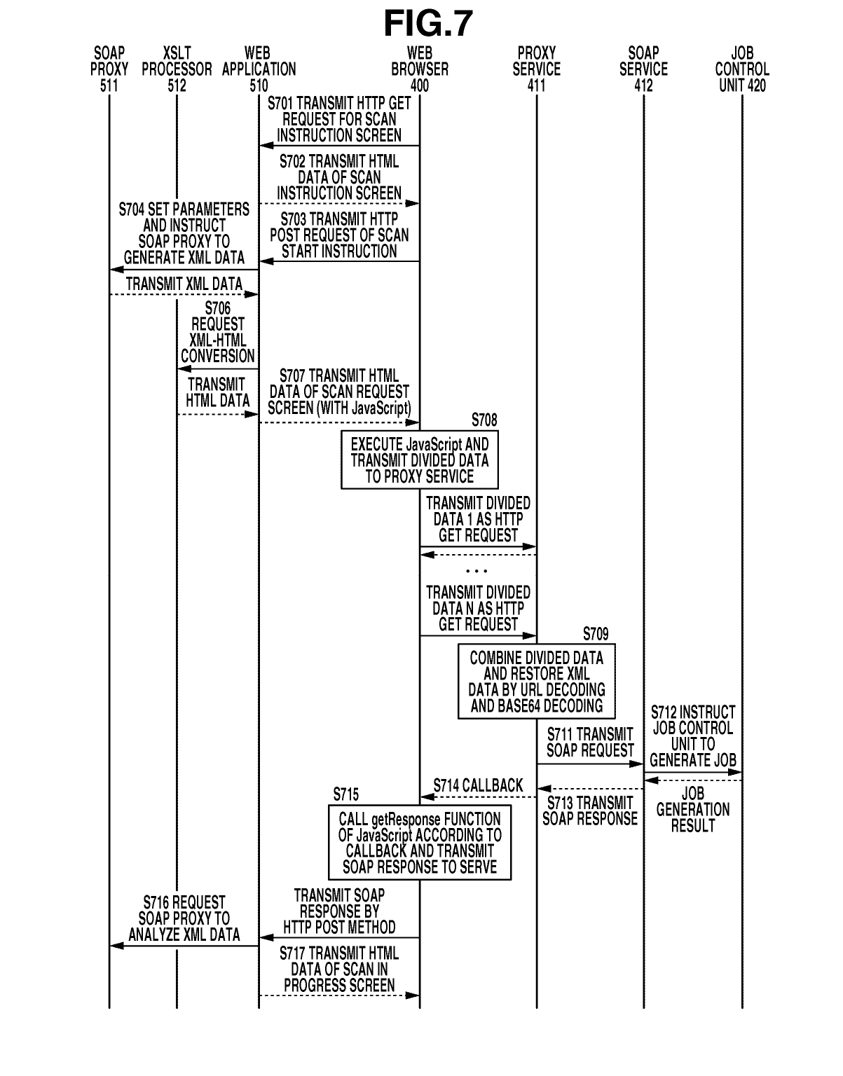

The proxy service 411 receives an HTTP request that the web browser 400 transmits as a result of the processing of the JavaScript (registered trademark) code. Then, the proxy service 411 analyzes the HTTP request received from the web browser 400, and restores a request that the server 102 generates to transmit to the SOAP service 412 (hereinafter referred to as a “SOAP request”) according to the analysis result. The method by which the server 102 generates the SOAP request, and the method by which the proxy service 411 restores the SOAP request are one of characteristic features of the present exemplary embodiment, and will be described in detail below (refer to FIG. 7).

After the proxy service 411 completes the restoration of the SOAP request to be transmitted to the SOAP service 412, the proxy service 411 transmits the SOAP request to the SOAP service 412. Further, when the proxy service 411 receives a response from the SOAP service 412 (hereinafter referred to as a “SOAP response”), the proxy service 411 generates a JavaScript (registered trademark) code for conducting a callback of the received SOAP response to the web browser 400. Then, the proxy service 411 transmits an HTTP response containing the generated JavaScript (registered trademark) code to the web browser 400.

The SOAP service 412 analyzes the received SOAP request, and generates a job control command for controlling the scanner 221 or the network I/F 218 of the MFP 101 to execute a job. Then, the SOAP service 412 transmits the job control command to the job control unit 420, and instructs the job control unit 420 to control the job (i.e., generate a job identification (ID) or the like).

Upon reception of a result of the job control instruction from the job control unit 420 (i.e., for example, whether a job is generated), the SOAP service 412 returns a SOAP response to the proxy service 411.

The job control unit 420 performs, for example, reading processing by the scanner 221 (a scan job), print processing by the printer 230 (a print job), and transmission processing via the network I/F 218 (a transmission job) by processing the job control command instructed by the SOAP service 412.

In the description of the present exemplary embodiment, a job of reading a document to generate a file, and transmitting the generated file to the server 102 will be described as an example of a job executed by the MFP 101. However, needless to say, the present exemplary embodiment can be also applied to a job of performing other processing such as print processing by the printer 220.

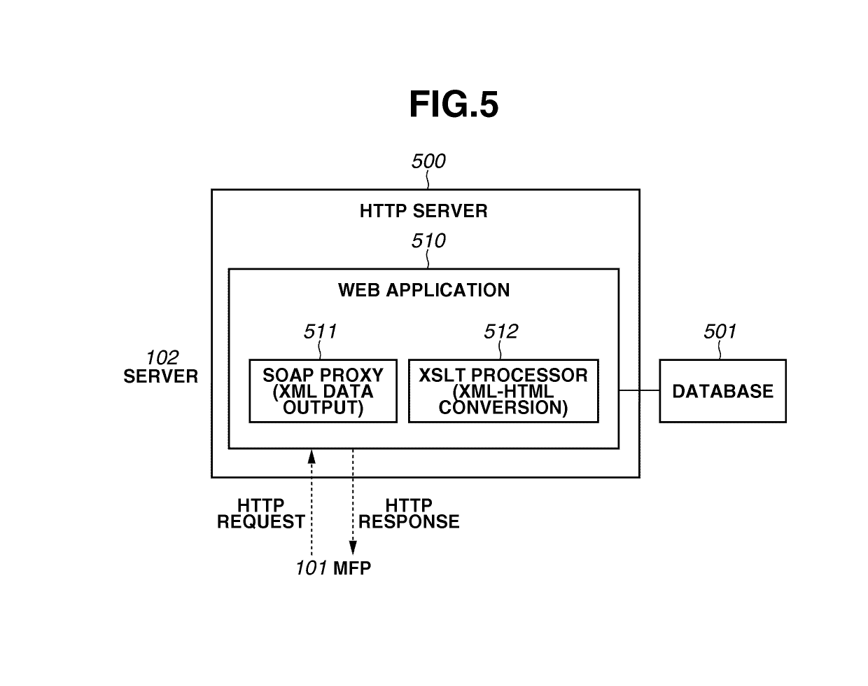

FIG. 5 is a view illustrating a software configuration of the server 102. The CPU 311 included in the server 102 executes the control program stored in the ROM 312, by which the respective functional units illustrated in FIG. 5 are realized.

The server 102 includes an HTTP server 500 and a database 501. The HTTP server 500 receives an HTTP request from the web browser 400, and assigns the received HTTP request to a web application 510 specified by a Uniform Resource Locator (URL).

The web application 510 generates HTML data to be displayed by the web browser 400 according to the HTTP request from the web browser 400. The web application 510 can also generate HTML data containing a JavaScript (registered trademark) code for transmitting an HTTP request to the proxy service 411 via the web browser 400 of the MFP 101.

The web application 510 transmits the generated HTML data to the web browser 400 as an HTTP response. Further, the web application 510 processes a file upload request transmitted from the job control unit 420, and registers the required data on the database 501.

The web application 510 includes a SOAP proxy 511 and an eXtensible Stylesheet Language Transformations (XSLT) processor 512 for generating data to be transmitted to the proxy service 411.

The SOAP proxy 511 generates a SOAP request to be transmitted to the SOAP service 412 based on a Web Services Description Language (WSDL) file, which defines an interface of the SOAP service 412. Further, the SOAP proxy 511 generates a SOAP request body as XML data.

The XSLT processor 512 encodes the XML data generated by the SOAP proxy 511 by performing BASE64 encoding and URL encoding (also known as “percent encoding”) in this order, and divides the encoded data into data pieces each having a predetermined size. Then, the XSLT processor 512 converts the divided data to HTML data containing a JavaScript (registered trademark) code according to eXtensible Stylesheet Language (XSL) data. The method for converting XML data into HTML data is one of the characteristic features of the present exemplary embodiment, and therefore will be described in detail below (refer to FIG. 7).

The database 501 manages data uploaded from the SOAP service 412 to the web application 510.

An overview of the system configuration according to the present exemplary embodiment is provided in the above description. Now, an overview of processing performed by the system according to the present exemplary embodiment will be provided in the following description.

### <Processing Performed by Information Processing System>

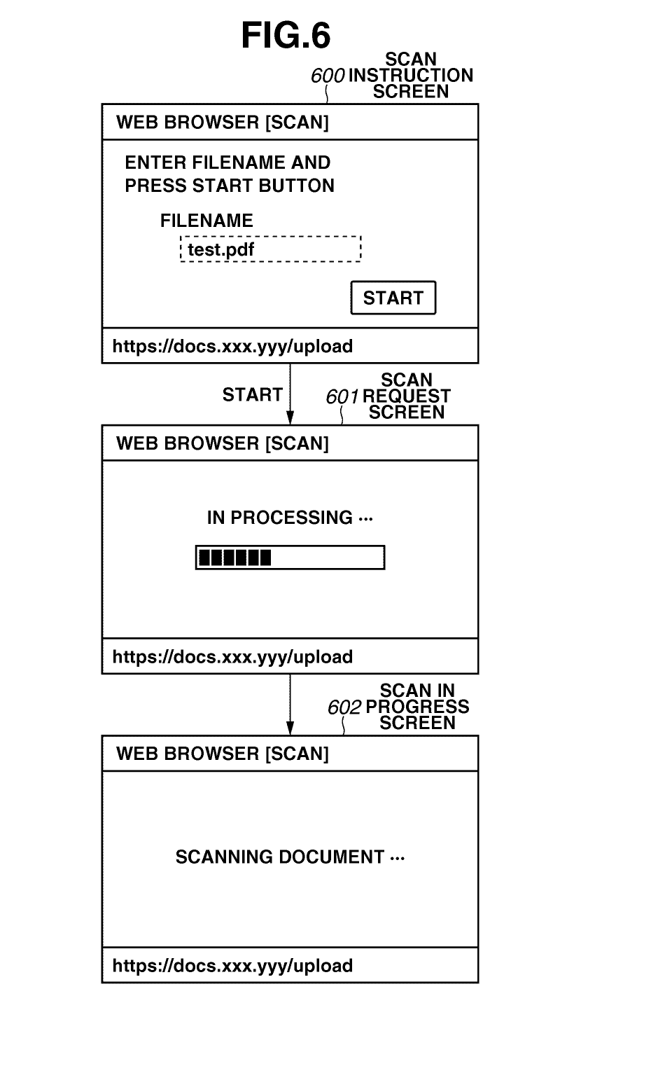

FIG. 6 is a view illustrating an example of transition of a screen displayed by the web browser 400 when the MFP 101 starts scan processing in the information processing system illustrated in FIG. 1. The web browser 400 processes HTML data returned from the web application 510, by which the respective screens illustrated in FIG. 6 are displayed. Now, the respective screens will be described in order.

A scan instruction screen 600 is a screen for issuing an instruction to start scan. The scan instruction screen 600 includes a filename input field and a start button. A name of a file (a filename) to be generated from scanning of a document is input in the filename input field. The start button is a button for instructing the web application 510 to start scanning a document. Upon pressing of the start button, the web browser 400 changes the screen from the scan instruction screen 600 to a scan request screen 601.

The scan request screen 601 is a screen displayed from issuance of the instruction to start scan on the scan instruction screen 600 until actual generation of a job. When a job is generated based on the scan request, the web browser 400 displays a scan in progress screen 602. The scan in progress screen 602 is a screen indicating that scan is started.

A sequence of processing performed by the information processing system illustrated in FIG. 1 will be described with reference to FIG. 7. According to the processing sequence illustrated in FIG. 7, processing in step S701 is started when the URL of the scan instruction screen 600 is input on the web browser 400 so that the web browser 400 is instructed to open the page.

In step S701, the web browser 400 transmits to the web application 510 an HTTP request as a request for acquisition of data required to display the scan instruction screen 600.

In step S702, the web application 510 transmits an HTTP response containing HTML data of the scan instruction screen 600 to the web browser 400 according to the request transmitted in step S701. The web browser 400 processes the received HTTP response, and displays the scan instruction screen 600 illustrated in FIG. 6.

Then, when a user presses the start button on the scan instruction screen 600, processing in step S703 is started. In step S703, the web browser 400 transmits an HTTP request for issuing an instruction to start scan to the web application 510. At this time, the web browser 400 also transmits a value (a filename) input in the filename input field on the scan instruction screen 600 to the web application 510.

In step S704, the web application 510 sets scan settings, document settings, and transmission settings to parameters of the SOAP proxy 511. According to the example of the scan instruction screen 600 illustrated in FIG. 6, the input filename is set to the parameter of the SOAP proxy 511 as one of transmission settings. However, the scan instruction screen 600 may be configured to accept an input of another scan setting, document setting, or transmission setting.

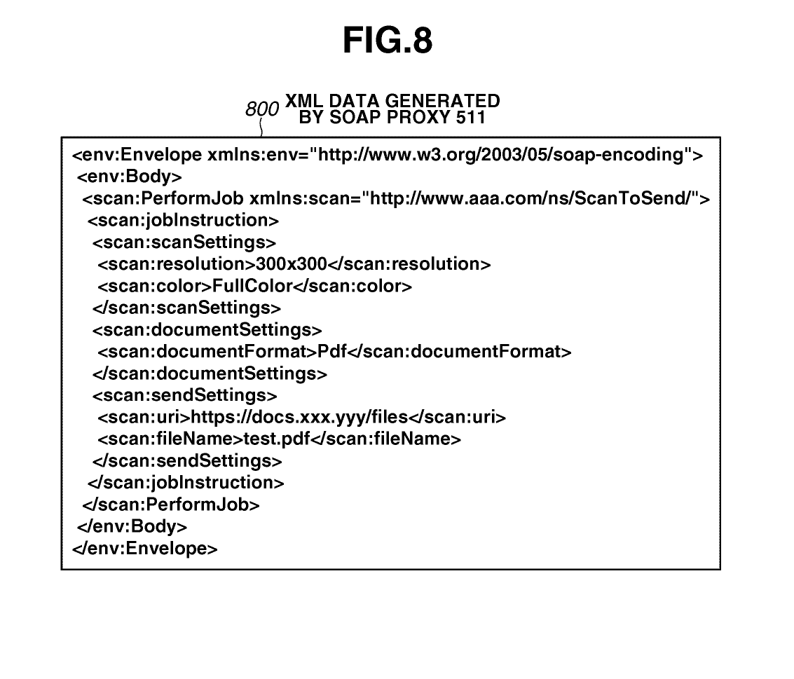

Subsequently, the web application 510 requests the SOAP proxy 511 to generate XML data. As a result, the SOAP proxy 511 generates XML data indicating an entity body of a SOAP request illustrated in FIG. 8, and returns the generated XML data to the web application 510.

FIG. 8 is a view illustrating an example of a SOAP request (XML data) output by the SOAP proxy 511 of the server 102. This XML data is a control command issuing an instruction to scan a document and generate a Portable Document Format (PDF) file therefrom, and then transmit the PDF file to the web application 510.

In the example in FIG. 8, a resolution of 300×300 and a full color mode are specified as scan settings, a PDF format is specified as document settings, and a transmission destination URL “https://docs.xxx.yyy/files” and a filename “test.pdf” are specified as send settings.

Subsequently, in step S706, the web application 510 requests the XSLT processor 512 to convert the XML data returned in step S704 into HTML data. Then, the XSLT processor 512 encodes the XML data by performing BASE64 encoding and URL encoding in this order, and divides the encoded data into data pieces each having the predetermined size. The divided size is determined in consideration of an upper limit for a URL processable by the web browser 400. In the present exemplary embodiment, the data is divided in such a manner that each divided data piece includes 256 characters or less.

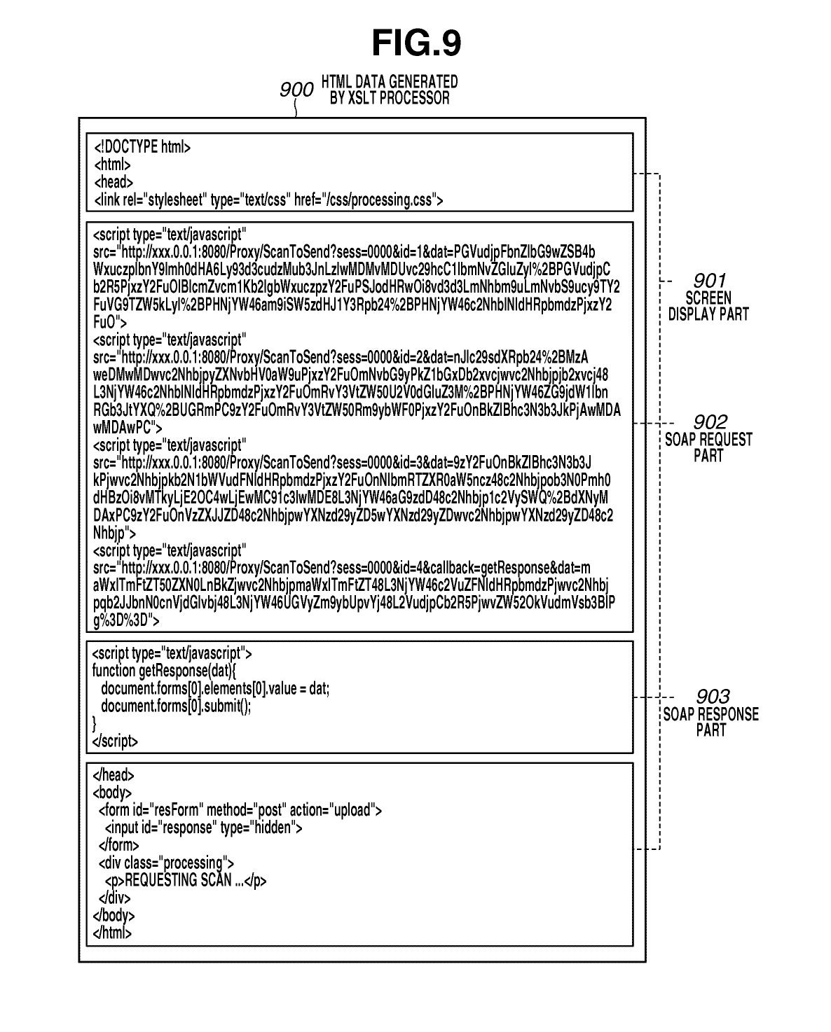

Then, the XSLT processor 512 generates HTML data containing a JavaScript (registered trademark) code (FIG. 9) according to the XSL specification, and returns the generated HTML data to the web application 510.

FIG. 9 is a view illustrating an example of the HTML data generated by the XSLT processor 512 of the server 102 for displaying the scan request screen 610. The HTML data includes a plurality of parts. More specifically, the HTML data includes a screen display part 901, a SOAP request part 902, and a SOAP response part 903. The respective parts will be described in detail below.

Screen data for displaying the scan request screen 601 illustrated in FIG. 6 is described in the screen display part 901. The web browser 400 analyzes the data described in the screen display part 901 to display the scan request screen 601 on the operation unit 219.

A plurality of “script” tags with a data structure described below is described in the SOAP request part 902 (a first script). The SOAP request part 902 includes descriptions of a procedure for transmitting the divided data pieces generated from the XML data illustrated in FIG. 8 to the SOAP service 412 and calling the web service.

More specifically, each of the plurality of “script” tags indicates that the following three data pieces are transmitted to a uniform resource identifier (URI) “http://xxx.0.0.1:8080/Proxy/ScanToSend” (i.e. the path to the proxy service 411). Each of the “script” tags indicates that data indicating a session ID specified in a query “sess”, data specified in a query “id”, and divided data specified in a query “dat” are transmitted. The data specified in the query “dat” is the above-described data piece encoded by BASE64 encoding and URL encoding, and divided to have the predetermined size.

The data size of a divided data piece is determined in consideration of the upper limit for a URL processable by the web browser 400. More specifically, the size of a divided data piece is determined in such a manner that a length of a character string of a URL specified in an “src” attribute in a “script” tag is 256 characters or less.

The SOAP request part 902 is described with use of the plurality of “script” tags in such a manner that all of the plurality of divided data pieces can be transmitted to the proxy service 411.

The data specified in the query “sess” is a session ID, based on which the proxy service 411 identifies a series of divided data pieces.

The data specified in the query “id” indicates what number divided data piece the relevant divided data piece is among the series of divided data pieces identified by the above-described session ID.

How the web browser 400 processes the SOAP request part 902 to transmit HTTP requests to the proxy service 411 will be described below in the description of step S708 (S710).

A callback function “getResponse”, which is called while taking a SOAP response transmitted from the proxy service 411 as an argument, is described in the SOAP response part 903 (a second script). In the present exemplary embodiment, the callback function “getResponse” is called by the proxy service 411 to upload a SOAP response as a result of the web service to the server 102.

The callback function “getResponse” is called as a response to an HTTP request transmitted to the proxy service 411 as a result of processing the “script” tags described in the SOAP request part 902 by the web browser 400. A mechanism for transmitting an HTTP request using a “script” tag and acquiring a response thereto by calling a defined callback function is called JavaScript Object Notation with Padding (JSONP). How the web browser 400 processes the SOAP response part 903 and receives a response from the proxy service 411 will be described below in the description of step S715.

In step S707, the web application 510 transmits an HTTP response containing the HTML data output by the XSLT processor 512 in step S706 to the web browser 400. When the process in step S707 is completed, the processing proceeds to step S708, from which the processing is taken over by the MFP 101.

In step S708, the web browser 400 of the MFP 101 processes the screen display part 901 to display the scan request screen 601. Then, the web browser 400 executes the script described in the SOAP request part 902, and transmits an HTTP request containing the divided data piece specified in the query “dat” illustrated in FIG. 9 to the proxy service 411. The transmission of the HTTP request from the web browser 400 to the proxy service 411 is repeated as many times as the number of the “script” tags contained in the SOAP request part 902. The example illustrated in FIG. 9 contains four “script” tags, so the process in step S708 is repeated four times.

In step S709, the proxy service 411 combines the divided data pieces contained in the HTTP requests received from the web browser 400 for each session. Then, after the proxy service 411 completes combining the divided data pieces of a single session, the processing proceeds to step S710.

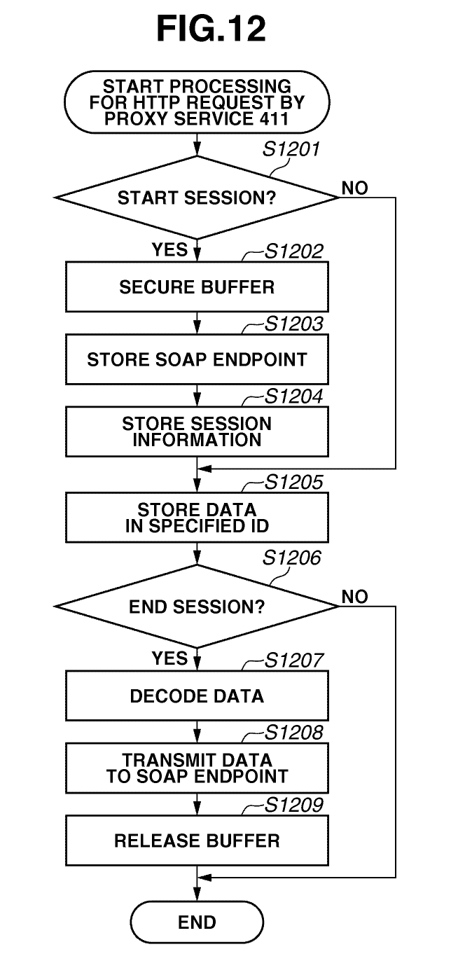

In step S710, the proxy service 411 decodes the data combined in step S709 by performing URL decoding and BASE64 decoding in this order. As described in step S706, the XSLT processor 512 encodes the XML data indicating the entity body of the SOAP request by performing BASE64 encoding and URL encoding in this order, and divides the encoded data into data pieces each having the predetermined size. Therefore, the entity body of the SOAP request is restored by combining the divided data pieces and performing URL decoding and BASE64 decoding on the combined data. The processing in which the proxy service 411 combines the received divided data pieces for each session and transmits the restored data to the specified SOAP service 412 will be described in detail below with reference to FIG. 12. After the process in S710 is completed, the processing proceeds to step S711.

In step S711, the proxy service 411 transmits a SOAP request to the SOAP service 412 based on the entity body of the SOAP request generated in step S710. After the SOAP service 412 receives the SOAP request, the processing proceeds to step S712.

In step S712, the SOAP service 412 interprets the SOAP request transmitted from the proxy service 411, and instructs the job control unit 420 to generate a job. When the SOAP service 412 instructs the job control unit 420 to generate a job, the job control unit 420 generates a job. When a job is successfully generated, and a job ID is assigned to the job, the processing proceeds to step S713.

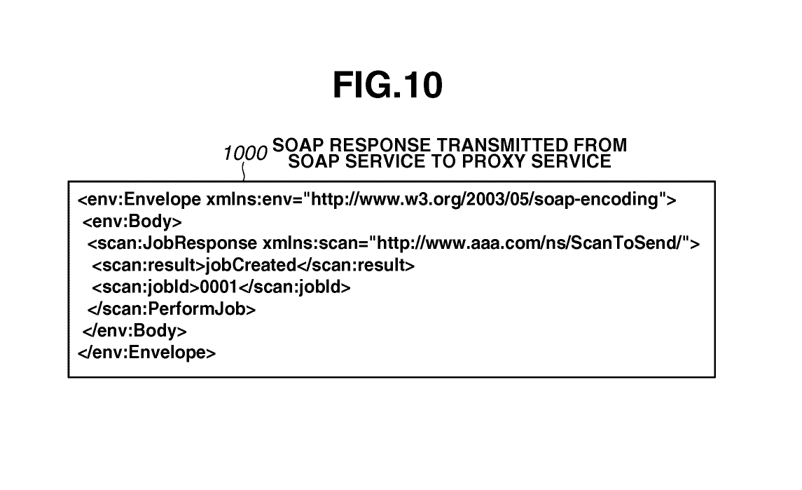

In step S713, the SOAP service 412 transmits to the proxy service 411 a SOAP response illustrated in FIG. 10 for returning the job generation result.

FIG. 10 is a view illustrating an example of a SOAP response output from the SOAP service 412 to the proxy service 411 of the MFP 101. The example illustrated in FIG. 10 indicates that a result of the instruction issued to the job control unit 420 for job generation is “success (jobCreated)”, and the job ID of the generated job is “0001”. After the process in step S713 is completed, the processing proceeds to step S714.

In step S714, the proxy service 411 transmits an HTTP response for conducting a callback of the SOAP response received in step S713, to the web browser 400.

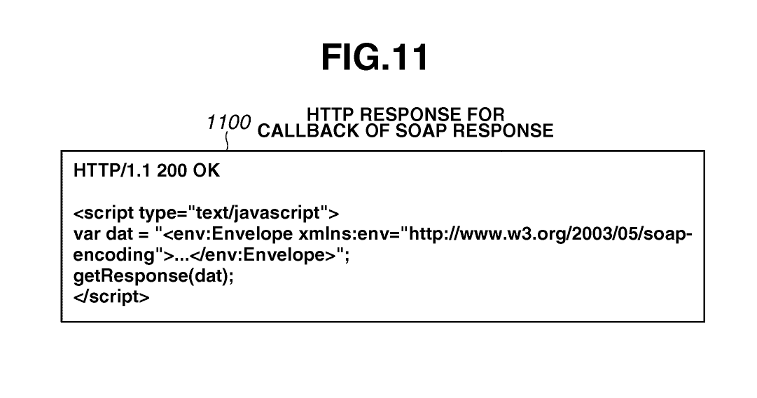

FIG. 11 is a view illustrating an example of an HTTP response for conducting the callback of the SOAP response, which is transmitted from the proxy service 411 to the web browser 400. More specifically, a process for calling the callback function “getResponse” taking the SOAP response illustrated in FIG. 10 as an argument is described in the JavaScript (registered trademark) language in the example illustrated in FIG. 11.

In step S715, the web browser 400 processes the HTTP response described in the JavaScript (registered trademark) language, which is received in step S714, and transmits a SOAP response to the web application 510. According to the SOAP response part 903 illustrated in FIG. 9, the web browser 400 first calls the callback function “getResponse”. Then, the web browser 400 submits the specified SOAP response to the web application 510 with use of a hidden form defined in the screen display part 901. In other words, the web browser 400 performs control to transmit the SOAP response specified in step S714 to the server 102 by executing the JavaScript (registered trademark) code contained in the HTTP response received in step S707.

After the process in step S715 is completed, the processing proceeds to step S716, from which the processing is taken over by the server 102.

In step S716, the web application 510 of the server 102 requests the SOAP proxy 511 to analyze the XML data of the SOAP response received in step S715. Then, the web application 510 determines the job generation result from a result of XML parsing of the SOAP response. In the example illustrated in FIG. 10, the result of the instruction to generate a job issued by the SOAP service 412 is “success (jobCreated)” as described above. Therefore, in step S717, the web application 510 transmits an HTTP response containing HTML data for displaying the scan in progress screen 602 (FIG. 6), which is to be displayed next, to the web browser 400.

Next, a flow of processing that the proxy service 411 performs to transmit a SOAP request to the SOAP service 412 will be described with reference to the flowchart illustrated in FIG. 12.

A control program for performing the processing illustrated in the flowchart in FIG. 12 is stored in the ROM 212, and is executed by the CPU 211. The processing illustrated in this flowchart is started each time the proxy service 411 receives the HTTP request containing the divided data piece from the web browser 400 in step S708.

In step S1201, the proxy service 411 analyzes the received HTTP request containing the divided data piece, and determines whether a new session is started.

More specifically, the proxy service 411 determines whether the session ID indicated in the query “sess” in the HTTP request, which is described in the SOAP request part 902 illustrated in FIG. 9, is stored in a buffer secured by the proxy service 411. If the session ID is not stored in the buffer, the proxy service 411 starts a new session.

If the proxy service 411 starts a new session (YES in step S1201), the proxy service 411 performs the processing in steps S1202 to S1204. If the session ID is stored in the buffer (NO in step S1201), the proxy service 411 determines that the divided data piece contained in the HTTP request received in step S708 is a divided data piece relating to an existing session. Then, the processing proceeds to step S1205.

In step S1202, the proxy service 411 secures a buffer for storing information regarding the new session.

In step S1203, the proxy service 411 stores an endpoint URI of the SOAP service 412 in the buffer secured in step S1202. More specifically, in the case of the example of the SOAP request part 902 illustrated in FIG. 9, a request URI to the proxy service 411 is “http://xxx.0.0.1:8080/Proxy/ScanToSend”. The proxy service 411 generates an endpoint URI of the SOAP service 412 as “http://xxx.0.0.1:8080/ScanToSend” from a protocol name “http”, a host name “xxx.0.0.1”, a port number “8080”, and a part of a pathname “ScanToSend” contained in the request URI. Then, the proxy service 411 stores the generated endpoint URI in the buffer.

Subsequently, in step S1204, the proxy service 411 stores the session ID indicated in the query “sess” in the buffer. In the case where the received data piece is the first divided data piece indicated in the SOAP request part 902 illustrated in FIG. 9, the proxy service 411 stores the value “0000” in the buffer, since the session ID indicated in the query “sess” is “0000”.

Subsequently, in step S1205, the proxy service 411 stores the divided data piece in the buffer. In the case of the example of the SOAP request part 902 illustrated in FIG. 9, the proxy service 411 stores the divided data piece indicated in the query “dat” in the buffer associated with the ID “1”, “2”, “3”, or “4” indicated in the query “id”.

In step S1206, the proxy service 411 determines whether to end the session. The proxy service 411 determines whether to end the session based on whether the proxy service 411 has received all of the divided data pieces for the same session. In the case of the example of the SOAP request part 902 illustrated in FIG. 9, a query “callback” is specified when the last divided data piece is requested. Therefore, the proxy service 411 determines that the data piece corresponding to the ID “4” is the last data piece, and determines that the session is ended when the proxy service 411 receives all of the divided data pieces having “1”, “2”, “3”, and “4” specified as the IDs. If the proxy service 411 determines to end the session (YES in step S1206), the proxy service 411 performs the processing in steps S1207 to S1209. On the other hand, if the proxy service 411 determines not to end the session (NO in step S1206), the processing of the present flowchart is ended.

Then, in step S1207, the proxy service 411 combines all of the divided data pieces stored in the buffer and decodes the combined data. In step S1208, the proxy service 411 transmits the decoded data to the endpoint URI of the SOAP service 412 stored in the buffer. In other words, the proxy service 411 transmits the SOAP request which is restored based on the divided data pieces to the SOAP service 412. After the transmission of the SOAP request is completed, the processing proceeds to step S1208. In step S1208, the proxy service 411 releases the buffer secured for the session, the transmission of which has been completed.

The first exemplary embodiment has been described above. According to the present exemplary embodiment, a web service published by the MFP 101 can be used without individually implementing a function extension to allow the web browser 400 to call the web service within the MFP 101.

A second exemplary embodiment of the claimed invention will be described. The second exemplary embodiment is different from the first exemplary embodiment in terms of the following feature. According to the second exemplary embodiment, processing for converting XML data 800 indicating a SOAP request into divided data pieces is not performed by the server 102. Instead, the web browser 400 processes a JavaScript (registered trademark) code described in the scan instruction screen 600, thus the conversion is realized.

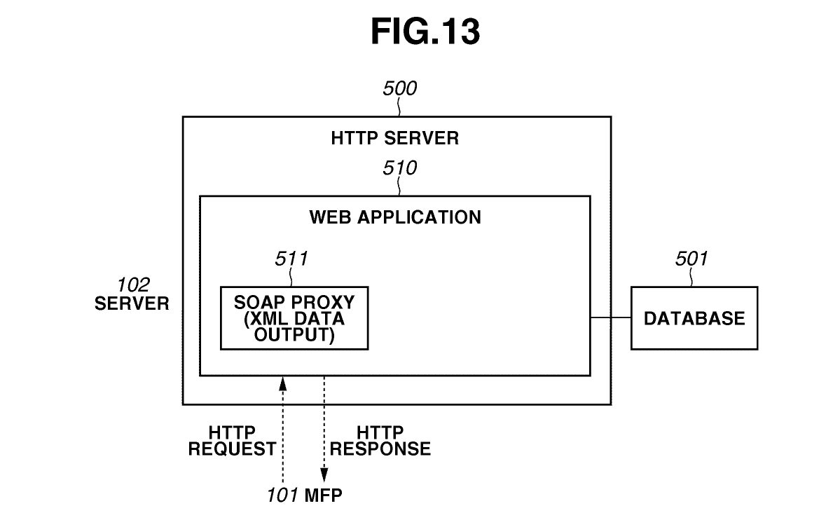

The difference from the first exemplary embodiment will be described with reference to FIGS. 13 to 15.

FIG. 13 is a view illustrating a software configuration of the server 102 according to the second exemplary embodiment. The software configuration of the server 102 is similar to that according to the first exemplary embodiment illustrated in FIG. 5, except that the web application 500 does not include the XSLT processor 512.

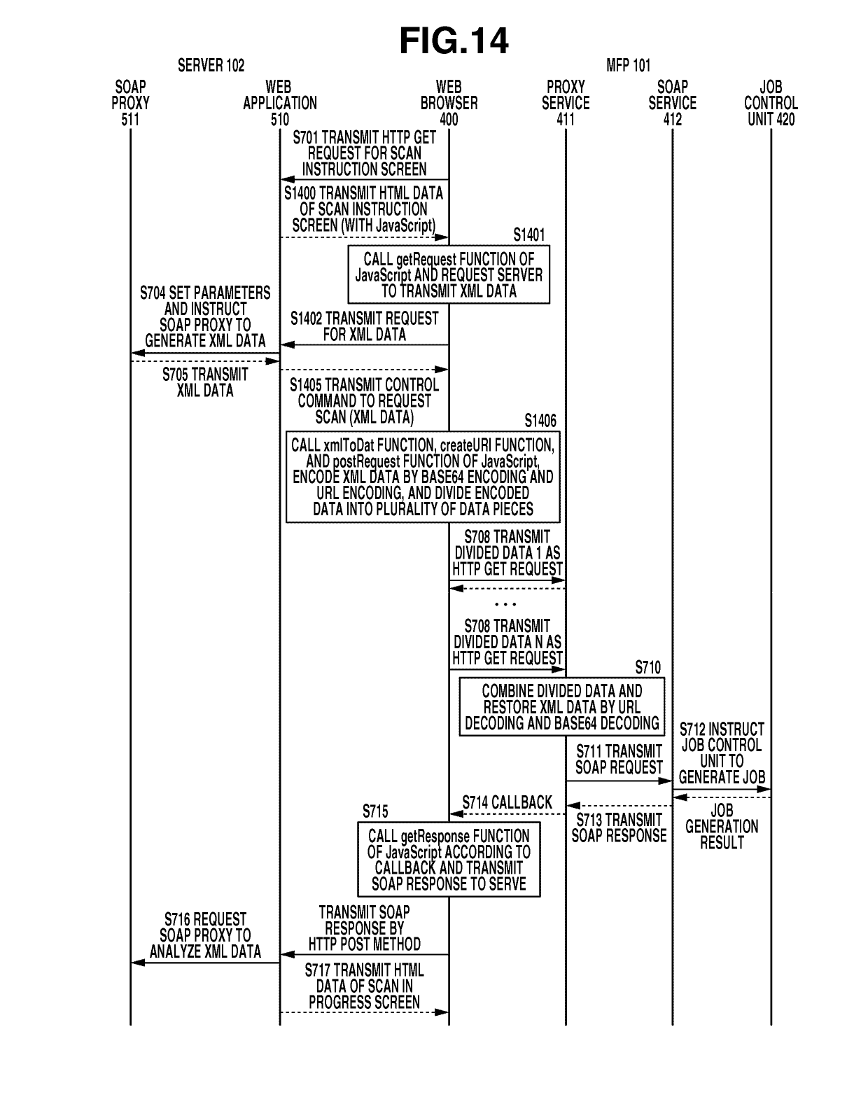

FIG. 14 illustrates a sequence of processing performed by the information processing system according to the second exemplary embodiment. In FIG. 14, the same number is assigned to a step in which the similar processing is performed to that in the processing sequence illustrated in FIG. 7, which is described in the first exemplary embodiment, and the descriptions thereof will be omitted.

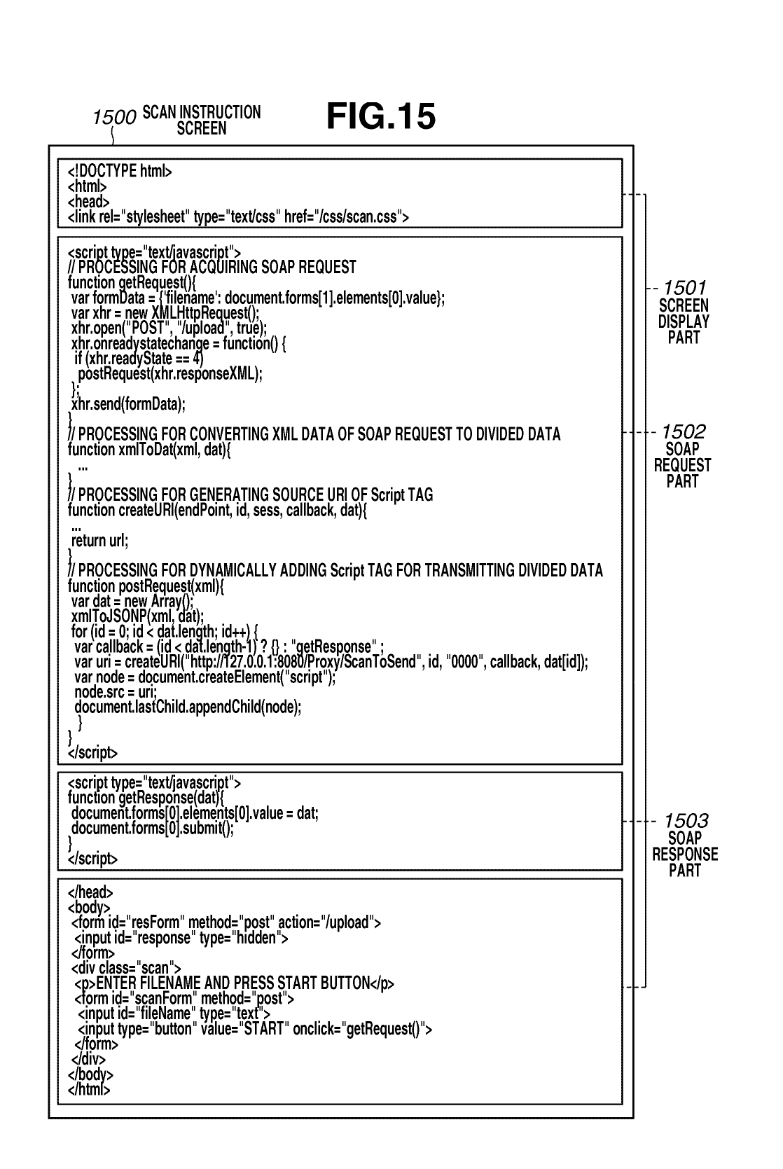

In step S1400, the web application 510 of the server 102 transmits HTML data containing a JavaScript (registered trademark) code as illustrated in FIG. 15 to the web browser 400 of the MFP 101 as a response to the request transmitted in step S701. In step S1401, the web browser 400 of the MFP 101 analyzes the HTML data received in step S1400, and displays the scan instruction screen 600 illustrated in FIG. 6.

FIG. 15 is a view illustrating an example of the HTML data indicating the scan instruction screen 600 according to the second exemplary embodiment. According to the first exemplary embodiment, the web browser 400 transfers the divided data pieces to the proxy service 411 by processing the JavaScript (registered trademark) code described in the scan request screen 601. On the other hand, according to the second exemplary embodiment, the web browser 400 transfers divided data pieces to the proxy service 411 by processing the JavaScript (registered trademark) code described in the HTML data for displaying the scan instruction screen 600.

According to the second exemplary embodiment, the scan request screen 601 is not returned from the web application 510, so the screen displayed by the web browser 400 is changed from the scan instruction screen 600 to the scan in progress screen 602.

Next, the processing in step S1401, namely how to process the JavaScript (registered trademark) code described in the HTML data indicating the scan instruction screen 600 will be described.

As illustrated in FIG. 15, the HTML data indicating the scan instruction screen 600 includes a plurality of parts. More specifically, the HTML data includes a screen display part 1501, a SOAP request part 1502, and a SOAP response part 1503.

The data for displaying the scan instruction screen 600 illustrated in FIG. 6 is described in the screen display part 1501. The web browser 400 analyzes the data described in the screen display part 1501 to display the scan instruction screen 600 on the operation unit 219. The screen display part 1501 includes form parts for instructing the web application 501 to start scanning a document. In the case of the example illustrated in FIG. 6, the screen display part 1501 includes a form part allowing a user to input a filename, and a form part allowing the user to submit the input filename.

In addition, the HTML data indicating the scan instruction screen 600 contains a “hidden form” for submitting a SOAP response to the web application 510 in a similar manner to the SOAP request part 902 of the scan request screen 601 according to the first exemplary embodiment.

Various functions are defined in the SOAP request part 1502. According to the present exemplary embodiment, a function “getRequest” and a function “postRequest” are contained in the SOAP request part 1502. If these functions are appropriately executed, the XML data received from the server 102 is converted into divided data pieces and a control command for calling the web service in the MFP 101 is transferred.

The function “getRequest” is a function for acquiring the XML data 800 (refer to FIG. 8) indicating the SOAP request from the web application 510. In step S1402, the function “getRequest” is called by submitting the form included in the screen display part 1501, and an HTTP request is transmitted to the web application 510 with use of an object “XMLHttpRequest”. Then, in step S1405, the web browser 400 receives the XML data 800 indicating the SOAP request from the web application 510 as an HTTP response.

In step S1406, the web browser 400 calls the function “postRequest” using the XML data 800 indicating the SOAP request contained in the HTTP response received in step S1405 as parameters.

According to the function “postRequest”, the web browser 400 encodes the XML data 800 received as an argument by performing BASE64 encoding and URL encoding in this order, and converts the encoded data into a plurality of divided data pieces. Then, the web browser 400 generates a source URI of the “script” tag for each of the plurality of divided data pieces. Lastly, the web browser 400 dynamically generates the “script” tag, and in step S708, transmits the divided data pieces to the proxy service 411. The data transmitted in step S708 is similar to the data transmitted in the first exemplary embodiment (HTTP request by the HTTP GET method).

As described above, the web browser 400 transmits the HTTP request similar to the HTTP request transmitted as a result of processing the SOAP request part 902 in the first exemplary embodiment, to the proxy service 411.

The SOAP response part 1503 is similar to the SOAP response part 903 of the scan request screen 601 in the first exemplary embodiment, and therefore the description thereof will be omitted.

According to the second exemplary embodiment, a web service published by the information processing apparatus can be used without individually implementing a function extension of the web browser 400.

Aspects of the claimed invention can also be realized by a computer of a system or apparatus (or devices such as a CPU, a micro processing unit (MPU), and/or the like) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a non-transitory computer-readable medium).

While the claimed invention has been described with reference to exemplary embodiments, it is to be understood that the claimed invention is not limited to the disclosed exemplary embodiments. The scope of the following claims is to be accorded the broadest interpretation so as to encompass all modifications, equivalent structures, and functions.

This application claims priority from Japanese Patent Application No. 2011-252925 filed Nov. 18, 2011, which is hereby incorporated by reference herein in its entirety.

What is claimed is:

1. An information processing apparatus communicable with an external apparatus via a network, the information processing apparatus comprising:
a web browser configured to transmit a HyperText Transfer Protocol (HTTP) request to the external apparatus, and receive an HTTP response including a first script in which a procedure for using a web service is described and a second script in which a procedure for transmitting a result of the web service to the external apparatus is defined, from the external apparatus according to the HTTP request; and
an HTTP server configured to perform processing as a web service provided by the information processing apparatus according to execution of the first script by the web browser, and call the second script for transmitting the result of the web service to the external apparatus,
wherein the web browser performs control to transmit the result of the web service to the external apparatus according to calling of the second script by the HTTP server.

2. The information processing apparatus according to claim 1, wherein the first script includes divided data which is generated from a Simple Object Access Protocol (SOAP) request in the external apparatus, and
wherein the HTTP server restores the SOAP request generated in the external apparatus from the divided data included in the first script, and performs processing as the web service according to the restored SOAP request.

3. The information processing apparatus according to claim 1, wherein a procedure for acquiring a Simple Object Access Protocol (SOAP) request generated in the external apparatus, a procedure for converting the SOAP request into a plurality of divided data pieces, and a procedure for transferring the divided data pieces to the HTTP server are described in the first script,
wherein the web browser acquires the SOAP request, converts the SOAP request into a plurality of divided data pieces, and transmits the plurality of converted divided data pieces to the HTTP server by executing the first script, and
wherein the HTTP server restores the SOAP request from the divided data pieces transmitted by the web browser, and performs processing as the web service according to the restored SOAP request.

4. A method for controlling an information processing apparatus communicable with an external apparatus via a network, the method comprising:
transmitting a HyperText Transfer Protocol (HTTP) request to the external apparatus;
receiving an HTTP response including a first script in which a procedure for using a web service is described and a second script in which a procedure for transmitting a result of the web service to the external apparatus is defined, from the external apparatus according to the HTTP request;
performing processing as a web service provided by the information processing apparatus according to execution of the first script;
calling the second script for transmitting a result of the web service to the external apparatus; and
transmitting the result of the web service to the external apparatus according to the calling of the second script.

5. A non-transitory computer-readable storage medium storing a program for causing an information processing apparatus communicable with an external apparatus via a network to execute:
transmitting a HyperText Transfer Protocol (HTTP) request to the external apparatus;
receiving an HTTP response including a first script in which a procedure for using a web service is described and a second script in which a procedure for transmitting a result of the web service to the external apparatus is defined, from the external apparatus according to the HTTP request;
performing processing as a web service provided by the information processing apparatus according to execution of the first script by a web browser;
calling the second script for transmitting a result of the web service to the external apparatus; and
transmitting the result of the web service to the external apparatus according to the calling of the second script by an HTTP server.
